(19) United States
(12) Patent Application Publication
(10) Pub. No.: US 2008/0209965 A1
(43) Pub. Date: Sep. 4, 2008

(54) Software-Controlled Mechanical Lock for Portable Electronic Devices

(75) Inventor: Hanns-Ingo Maack, Norderstedt (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,713

(22) PCT Filed: Jul. 18, 2006
(86) PCT No.: PCT/IB2006/052462

§ 371 Date: Jan. 15, 2008

(30) Foreign Application Priority Data
Jul. 21, 2005 (EP) 05106675.1

(51) Int. Cl. E05B 73/00

(52) U.S. Cl. 70/262; 726/35

(57) ABSTRACT

A security system for preventing unauthorised removal of a portable electronic device, such as a portable X-ray detector (106) or the like, from a docking station (100). The docking station (100) is provided with an electromagnetic lock (102) which is activated by means of a software command (112) issued by a screensaver function (110) running on a remote host PC (108). When triggered after some predetermined period of user inactivity, the screensaver function (110) locks the screen and keyboard of the host PC (108) to prevent unauthorised use thereof, and also issues the above-mentioned software command (112) to activate the electromagnetic lock (102) and prevent removal of the detector (106) from the docking station (100).

This invention relates to a software controlled mechanical lock for the prevention of theft of portable electronic devices such as battery-powered medical and consumer electronic devices.

Portable (wireless) consumer electronic devices, such as personal digital assistants (PDAs) and the like, are in widespread use. Portable medical electronic devices, such as portable X-ray detectors and the like, are also well known, and are similar in many respects to portable consumer electronic devices, including the fact that they tend to be stored in respective docking stations when they are not in use. In general, when such a device is located in its docking station, the battery is re-charged.

Due to the highly portable nature of these types of devices, they are relatively easy to steal. For example, a portable X-ray detector will be stored in a docking station when it is not in use, which docking station is likely to be located in a hospital room to which a lot of people have access. Thus, security measures to prevent theft these expensive devices need to be taken.

It is known to provide a purely mechanical lock with a specific standardised hardware interface to an electronic device, to secure the device to, for example, the docking station when it is not in use. This type of lock is, of course, effective in preventing unauthorised removal of a device from its docking station, but it requires the use of a hardware key to secure or release the device. Thus, in practice, it may become necessary to mechanically lock and unlock a device several times a day, which is obviously inconvenient. In the case of portable medical devices in particular, each authorised member of staff would have to have their own key, such that this system becomes impractical and is likely to result in the device being left permanently unsecured.

It is also known to provide software locks in the form of screensavers and the like, where no mechanical component is present. A screensaver can be started interactively, but is typically triggered by a timer after some predefined period of user inactivity. In some cases, a password is required to be entered to deactivate the screensaver once it has been triggered. However, the purpose of a screensaver is to prevent unauthorised access to, and use of, the device. It does not prevent the device from being physically removed.

U.S. Pat. No. 6,590,597 describes a software-based screen locking function for a computer system in which a universal serial bus (USB) hub connects the information input devices (e.g. mouse keyboard) and the display to the main computer system, through which USB hub the screen locking function is set to disable the operation of the information input devices in the event that a user temporarily leaves the computer system, so as to prevent unauthorised use thereof. However, once again, this type of screen locking function does not prevent the physical removal of the device by an unauthorised person.

Thus, it is in object of the present invention to provide a security system for a portable electronic device for preventing unauthorised removal thereof from a docking station without the need to perform repeated mechanical operations to selectively activate and deactivate the security system.

In accordance with the present invention, there is provided a security system for an electronic device, the security system comprising a software-based security function operable to disable one or more functions of a remote host computing device and to enable said one or more functions in response to entry of valid security data, said security function comprising means for generating, when said one or more functions are disabled or enabled, an electrical signal for transmission to a mechanical lock associated with said electronic device to respectively activate or deactivate said mechanical lock.

Thus, the present invention provides a security system in which a mechanical lock is activated as a result of the triggering of a screensaver or similar software-based security function, which mechanical lock is then releasable by the normal deactivation of the security function, for example, by the entry of a password.

Beneficially, the software-based security function comprises a screensaver, which is preferably triggered to disable said one or more functions after a predetermined period of user inactivity in respect said host computing device. The mechanical lock beneficially comprises an electromagnetic lock, arranged to lock said electronic device in a base station, such as a docking station or the like. The mechanical lock is beneficially activated when said host computing device is off.

The present invention extends to an electronic device comprising means for docking said device within a base station, a mechanical lock for securing said device within said base station, and means for receiving electrical signals from a remote host computing device so as to activate said mechanical lock when one or more functions of said host computing device are disabled by a software-based security function and to deactivate said mechanical lock when said one or more functions of said host computing device are enabled in response to entry of valid security data.

These and other aspects of the present invention will be apparent from, and elucidated with reference to, the embodiment described herein.

An embodiment of the present invention will now be described by way of example only and with reference to the accompanying drawings, in which:

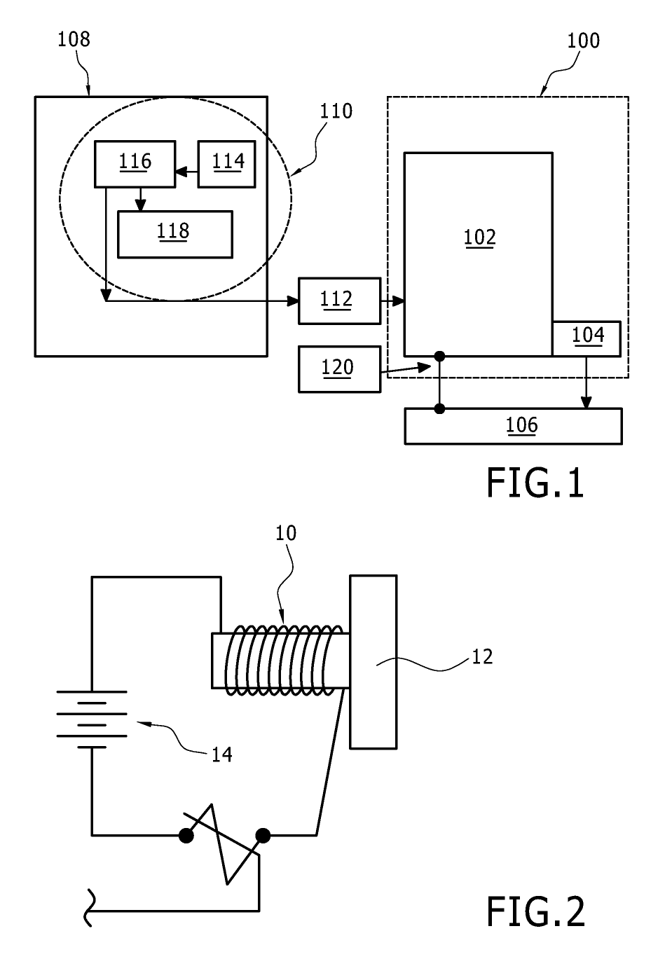

FIG. 1 is a schematic block diagram illustrating the principal components of a security system according to an exemplary embodiment of the present invention;

FIG. 2 is a schematic diagram illustrating the principal components of an electromagnetic lock.

In general, the present invention is based on the principle of using a mechanical lock that can be opened by means of electrical signals as well as a hardware key. More specifically, the lock is controlled by the operation of a software security function, such as a screensaver, which is triggered after a predefined time of user inactivity (or interactively by a user) to prevent unauthorised use of a device. When the software function is deactivated in the normal way, for example, by entering a password, the mechanical lock is also opened, so that no additional user interaction is required in respect of the mechanical lock. In other words, when the screensaver is active, the device is locked and once the screen has been unlocked, the mechanical lock is also open and the device can be removed.

Referring to FIG. 1 of the drawings, a security system according to an exemplary embodiment of the present invention comprises an electromagnetic lock 102 housed in a docking station 100 arranged and configured to receive a portable X-ray detector 106. The docking station 100 is provided with a power supply 104 which is connected to the detector 106 when it is docked so as to re-charge its battery.

Electromagnetic locks are well known and many different types exist. Referring additionally to FIG. 2 of the drawings, in its simplest form, one type of electromagnetic lock 102 consists of an electromagnet 10 mounted in or on, say, the docking station 100 and a matching ferromagnetic plate 12 that is affixed to the portable X-ray detector 106. The electromagnet 10 comprises an electric circuit wound in a helix or solenoid so that the passage of current through the circuit produces a magnetic field, and the ferromagnetic plate is thus responsive to the electromagnetic field when the electromagnet 10 is energised. The electromagnet is connected to the power supply 104, which supplies the power required to electrically energise the electromagnet 10 during normal operation. A battery 14 is also provided, which provides power for electrically energising the electromagnet 10 when the docking station 100 is not connected to an external power source or when the host PC 108 is switched off, for example, overnight or as a result of a power failure. In an alternative embodiment, the electromagnetic lock may be bi-stable being in both the open and closed configuration without the need for power. In other words, if the lock is closed it will remain closed without power, if the lock is open, it will remain open without power, but a voltage is required to change the state of the lock from open to closed and the application of a negative voltage will open it again. Without voltage, the state of the lock (whether open or closed) cannot be changed.

It will be appreciated that there are many different configurations of electromagnetic lock which would be suitable for use in various exemplary embodiments of the present invention, and it will be understood that the present invention is not intended to be limited in this regard.

When the portable X-ray detector 106 is in the docking station 100 such that the electromagnet 10 and ferromagnetic plate are engaged, and when the electromagnetic lock is locked, the electromagnet 10 attracts the plate 12 with enough force that the detector 106 cannot be removed from the docking station 100 using normal manual force. When the electromagnetic lock is open, no electromagnetic field is generated and the detector 106 can be removed from the docking station 100 using normal manual force.

Thus, in a preferred embodiment, a bi-stable mechanical lock is provided which is activated and deactivated by the application of a voltage of suitable priority to the electromagnet 10. Referring back to FIG. 1 of the drawings, this is achieved by means of software commands 112 received from the host PC 108 via the screensaver function 110.

Screensaver functions are well known in the art. A screensaver is a computer program originally designed to conserve the image quality of computer displays by blanking the screen or filling it with moving images or patterns when a computer is not in use. More recently, however, are primarily for entertainment purposes. Screensaver software has also been adapted as a security measure. Many screensavers can lock the workstation such that, once activated, can be programmed to ask users for a password before permitting the user to resume work. This means that, for example, a host PC to which the docking station for a portable X-ray detector is connected will have a screen saver to secure patient-related information and prevent access thereto by unauthorised people when there are no authorised personnel present. Only authorised personnel will know the password to unlock the screen saver.

Thus, a typical screensaver function comprises a timer 114 which triggers the screensaver 116 after a predefined time of user inactivity. The screensaver issues a software command to lock (at 118) the screen and input device (i.e. keyboard, mouse) such that they cannot be used. In addition, the screensaver 116 issues a software command 112 to the electromagnetic lock 102 to activate and thereby prevent the detector 106 from being removed from the docking station 100. Once an authorised user has entered a valid password at the host PC 108, the screensaver unlocks the screen and keyboard so the user can resume work, and also issues another software command 112 to supply a negative voltage to the electromagnet 10 so as to unlock it and allow the detector 106 to be removed from the docking station 100 as required.

Thus, the electromagnetic lock 102 is:

LOCKED When “SCREEN=LOCKED” OR “Host-PC=OFF”

The electromagnetic lock 102 may also be operable by means of a hardware key via a hardware key interface 120. However, such a hardware key will generally only be required at the time of installation and in the unlikely event of a malfunction which prevents the host PC 108 from effectively controlling the lock 102. beneficially, the hardware key will always overrule the software commands, but it will generally only be required to open the lock: the LOCK state is preferably the default state and requires no action.

In summary, therefore, the principle of the present invention is to control a mechanical lock using a software-based security function, such as a screensaver, such that when the security function is active, the device is mechanically locked, but once the workstation has been unlocked, the device is also unlocked. It will be appreciated, of course, that the docking station will be required to be secured in some way, for example, screwed to a wall or other surface. The hardware lock requires no additional user interaction above that which is already required as a matter of routine to operate the software-based security function. Thus, the device is automatically secured in idle mode without user action, no hardware keys are required during routine operation, the password for the security function is sufficient for all security tasks.

There are many different applications envisaged for the system of the present invention. The system is, of course particularly suited for all battery-powered medical devices, including X-ray detectors, ekg sensors, pulse sensors, blood oxygen sensors, blood measure sensors, temperature sensors, perfusion pumps, IV drip controllers, patient identification tags or wrist bands, pacemakers, respirators and MRI coils. The system is also suitable for use with consumer electronic devices, whether portable or otherwise. For example, all battery-powered consumer devices with a docking station, such as PDAs, can be protected using the system of the present invention, but also non battery-powered devices such as, for example, a TFT monitor which may be connected to the host PC by means of a specific rigid connection ending in remotely controlled locks on one or both sides of the PC and display. Thus, nobody could steal the monitor without the PC, but an authorised user could exchange the components relatively easily. Indeed all electronic devices may potentially be protected by means of the system of the present invention, and the present invention is not necessarily intended to be limited in this regard.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A security system for an electronic device (106), the security system comprising a software-based security function (110) operable to disable one or more functions of a remote host computing device (108) and to enable said one or more functions in response to entry of valid security data, said security function (110) comprising means (116) for generating, when said one or more functions are disabled or enabled, an electrical signal (112) for transmission to a mechanical lock (102) associated with said electronic device (106) to respectively activate or deactivate said mechanical lock (102).

2. A system according to claim 1, wherein said software-based security function (110) comprises a screensaver (116).

3. A system according to claim 2, wherein said screensaver (116) is triggered to disable said one or more functions after a predetermined period of user inactivity in respect said host computing device (108).

4. A system according to claim 1, wherein said mechanical lock (102) comprises an electromagnetic lock, arranged to lock said electronic device (106) in a base station (100).

5. A system according to claim 1, wherein said mechanical lock (102) is activated when said host computing device (108) is off.

6. An electronic device (106) comprising means for docking said device within a base station (100), a mechanical lock (102) for securing said device (106) within said base station (100), and means for receiving electrical signals (112) from a remote host computing device (108) so as to activate said mechanical lock (102) when one or more functions of said host computing device (108) are disabled by a software-based security function (110) and to deactivate said mechanical lock (102) when said one or more functions of said host computing device (108) are enabled in response to entry of valid security data.
